(19) United States
(12) Patent Application Publication
(10) Pub. No.: US 2026/0126002 A1
(43) Pub. Date: May 7, 2026

(54) Turbine Arrangement for Turbo Device, Turbo Device, Internal Combustion Engine, and Vehicle

(71) Applicant: Scania CV AB, Södertälje (SE)

(72) Inventors: Magnus Lindgren, Älvsjö (SE); Viktor Olsson, Johanneshov (SE); Dag Eriksson, Älta (SE); Olle Bodin, Trosa (SE); Joakim Kain, Vendelsö (SE)

(21) Appl. No.: 19/114,317

(22) PCT Filed: Sep. 20, 2023
(86) PCT No.: PCT/SE2023/050922

§ 371 Date: Mar. 21, 2025

(30) Foreign Application Priority Data
Sep. 22, 2022 (SE) 2251095-2

(51) Int. Cl. F01N 3/20; F02B 39/00

(52) U.S. Cl. CPC F01N 3/208; F02B 39/00; F01N 2900/1402

(57) ABSTRACT

A turbine arrangement is disclosed for a turbo device of an internal combustion engine. The turbine arrangement comprises a turbine housing and a turbine unit. The turbine housing comprises an exhaust conducting section comprising a turbine shroud and a turbine outlet duct, a first opening provided in a wall of the exhaust conducting section, and a chamber fluidly connected to the exhaust conducting section via the first opening. The turbine arrangement comprises a sensor arranged to sense a property of gas inside the chamber. The present disclosure further relates to a turbo device, an internal combustion engine comprising a turbo device, and a vehicle.

### TECHNICAL FIELD

The present disclosure relates to a turbine arrangement for a turbo device of an internal combustion engine. The present disclosure further relates to a turbo device for an internal combustion engine, an internal combustion engine comprising a turbo device, and a vehicle comprising an internal combustion engine.

### BACKGROUND

Turbo devices are used on internal combustion engines to increase the performance and/or the fuel efficiency of the engine. One type of turbo device is a turbocharger. A turbocharger comprises a turbine unit and a compressor, wherein the turbine unit is driven by exhaust gas of the engine to power the compressor. The compressor forces air to an air inlet of the engine which allows more fuel to be added and hence higher power output of the engine. A turbocharger is an efficient means of supercharging an engine since it utilizes energy of the exhaust gasses of the engine to compress the inlet air of the engine.

Another type of turbo device is a turbo compound. A turbo compound also comprises a turbine unit driven by exhaust gas of the engine. However, instead of powering a compressor, the energy recovered from the exhaust gasses is sent to an output shaft of the engine or is used for another purpose, such as powering an electric generator, or the like. The produced electricity can be used to produce motive power to the vehicle in an electric machine or can be used to power one or more other subsystems of the vehicle. A turbo compound is an efficient means of increasing the total fuel efficiency since it is capable of converting part of the energy of the exhaust gases into useful energy.

Since the turbine unit of a turbo device is configured to extract energy of the exhaust gasses of the engine, the temperature and the pressure of the exhaust gas is, in most cases, higher upstream of the turbine unit than downstream of the turbine unit.

Environmental concerns, as well as emissions standards for motor vehicles, have led to the development of combustion engine assemblies using exhaust additives, such as reducing agents for diesel, and/or ethanol, exhaust gases. Reducing agents may comprise an aqueous urea solution and may be used as a consumable in a Selective Catalytic Reduction SCR catalyst in order to lower nitrogen oxides NOx concentration in exhaust emissions from the internal combustion engine.

Nitrogen oxides NOx are formed by a reaction between oxygen O2 and nitrogen N upon high temperatures and pressures in a cylinder of an engine. In other words, when the operation of the engine is optimized regarding fuel efficiency, large amounts of nitrogen oxides NOx may be formed. The term NOx represents several forms of nitrogen oxides including nitric oxide NO and nitrogen dioxide NO2.

A selective catalytic reduction arrangement is a means of converting nitrogen oxides NOx with the aid of a catalyst into diatomic nitrogen N₂, and water H₂O using a reduction agent added to a stream of exhaust gas which is adsorbed onto a catalyst substrate of the SCR catalyst. The reduction agent may comprise a gaseous reductant, typically anhydrous ammonia, aqueous ammonia, or urea. Some exhaust systems have been developed comprising two or more SCR catalysts arranged in series.

In internal combustion engines comprising a turbo device and one or more SCR catalysts, the SCR catalyst/catalysts is/are usually arranged downstream of the turbine unit of the turbo device. In this manner, the SCR catalyst/catalysts has/have a low impact on the flow of exhaust gas from exhaust valves of the combustion engine to the turbine unit.

The use of exhaust additives is associated with some problems and design difficulties. One problem is the requirement for an efficient mixing in order to achieve uniform distribution of exhaust additive over the entire surface area of a catalyst substrate. The space available for mixing is limited which may cause an insufficient mixing of the exhaust additive and the exhaust gas upstream of the catalyst substrate. An insufficient mixing between the exhaust additive and the exhaust gas reduces the reduction efficiency at the catalyst substrate and may cause formation of deposits of the exhaust additive inside the exhaust system.

Modern engines usually comprise various sensors arranged to sense a property of the exhaust gas of the engine, such as one or more NOx sensors, one or more oxygen sensors, and one or more temperature sensors. A nitrogen oxide sensor, also referred to as a NOx sensor, is a device which can be used to detect nitrogen oxides in a stream of exhaust gas from an internal combustion engine.

A NOx sensor can be arranged downstream of a SCR catalyst to measure the NOx content in the exhaust gas downstream of the SCR catalyst. In this manner, the NOx conversion rate of the SCR catalyst can be monitored. Moreover, a NOx sensor can be arranged upstream of the first SCR catalyst of an exhaust system. In this manner, the NOx generation of the internal combustion engine can be monitored.

The placement of various types of sensors in an exhaust system of an internal combustion engine is a problem. For example, sensors, such as NOx sensors, are sensitive components which may become damaged if subjected to too high temperatures and pressures. Moreover, some types of sensors, such as NOx sensors, are not able to provide reliable data at too high pressures and/or temperatures.

Moreover, the injection of exhaust additive into a stream of exhaust gas may cause disturbances of the measurements obtained by a sensor and the sensor can provide erroneous data if mounted to close to an exhaust additive injection point in the exhaust system. As an example, a NOx sensor can register ammonia of an exhaust additive as NOx. Moreover, as indicated above, the space available inside an exhaust system is limited and it may be difficult to position an exhaust additive dosing unit to obtain a sufficient mixing between the exhaust additive and the exhaust gas before the mixture reaches the catalytic substrate.

### SUMMARY

It is an object of the present invention to overcome, or at least alleviate, at least some of the above-mentioned problems and drawbacks.

According to a first aspect of the invention, the object is achieved by a turbine arrangement for a turbo device of an internal combustion engine. The turbine arrangement comprises a turbine housing and a turbine unit arranged to rotate in the turbine housing. The turbine housing comprises an exhaust conducting section comprising a turbine shroud and a turbine outlet duct, a first opening provided in a wall of the exhaust conducting section, and a chamber fluidly connected to the exhaust conducting section via the first opening. The turbine arrangement comprises a sensor arranged to sense a property of gas inside the chamber. The turbine outlet duct comprises a second opening provided in the wall of the exhaust conducting section, wherein the chamber is fluidly connected to the exhaust conducting section via the second opening. The turbine outlet duct comprises a first and a second end portion, wherein the first end portion is arranged at an interface between the turbine shroud and the turbine outlet duct. The second opening is arranged closer to the first end portion than to the second end portion.

Thereby, conditions are provided for obtaining reliable data of the property of the gas inside the chamber, while avoiding damages to the sensor caused by excessive temperatures and/or pressures. This is because the sensor is arranged to sense a property of the gas inside the chamber which is fluidly connected to the exhaust conducting section via the first opening provided in the wall of the exhaust conducting section. The temperature and pressure of the exhaust gas flowing through the exhaust conducting section is lower than the exhaust gas upstream of the exhaust conducting section because the turbine unit is arranged to rotate in the turbine housing and extract energy from the flow of exhaust gas.

Since the chamber is fluidly connected to the exhaust conducting section via the first opening, the chamber is filled with exhaust gas during operation of the turbine arrangement. As a result thereof, the property of the exhaust gas in the chamber during operation of the turbine arrangement is representative of a property of exhaust gas flowing through the turbine unit. Thus, due to these features, conditions are provided for obtaining reliable data of the property of the exhaust gas flowing through the turbine unit, while avoiding damages to the sensor caused by excessive temperatures and/or pressures.

Moreover, due to these features, conditions are provided for injecting an exhaust additive to the exhaust gas at a position close to the turbine unit of the turbine arrangement without disturbing the measurements obtained by the sensor. This is because the sensor is arranged to sense a property of the gas inside the chamber which is fluidly connected to the exhaust conducting section via the first opening.

Accordingly, due to these features, a turbine arrangement is provided having conditions for providing reliable data of the property of exhaust gas flowing through the turbine unit, while being robust and having conditions for adding exhaust additive to the exhaust gas at a position close to the turbine unit of the turbine arrangement to obtain a high degree of mixing between the exhaust additive and the exhaust gas without disturbing the measurements obtained by the sensor.

Moreover, since the turbine outlet duct comprises the second opening provided in the wall of the exhaust conducting section, wherein the chamber is fluidly connected to the exhaust conducting section via the second opening, it can be further ensured that the gas inside the chamber is exchanged continuously by a continuous flow of exhaust gas through the chamber. In this manner, conditions are provided for obtaining even more reliable data of the property of exhaust gas flowing through the turbine unit.

Furthermore, since the second opening is arranged closer to the first end portion than to the second end portion, each of the first and second openings can be arranged close to the turbine outlet of the turbine unit while obtaining a continuous exchange of the gas inside the chamber. As a further result, conditions are provided for injecting an exhaust additive to the exhaust gas at a position close to the turbine unit of the turbine arrangement impairing the reliability of the measurements obtained by the sensor.

Accordingly, a turbine arrangement is provided overcoming, or at least alleviating, at least some of the above-mentioned problems and drawbacks. As a result, the above-mentioned object is achieved.

Optionally, the first opening faces the turbine unit. Thereby, it can be ensured that reliable data is obtained from the sensor also at transient operation of the internal combustion engine. This is because the facing of the first opening towards the turbine unit can ensure that the gas inside the chamber is exchanged continuously by pressure fluctuations at the first opening and/or by obtaining a continuous flow of exhaust gas into the first opening.

Optionally, the chamber is arranged radially outside of the turbine outlet duct and encloses more than 25%, or more than 50%, of the circumference of the turbine outlet duct. Thereby, a space efficient chamber is provided for the mounting of the sensor. Moreover, conditions are provided for arranging the second opening at a different circumferential position of the exhaust conducting section than the first opening.

Optionally, the first opening is provided in a wall of the turbine outlet duct at a position closer to the first end portion than to the second end portion. Thereby, further improved conditions are provided for injecting an exhaust additive to the exhaust gas at a position close to the turbine unit of the turbine arrangement without disturbing the measurements obtained by the sensor. Moreover, since the first opening is provided in a wall of the turbine outlet duct, the exchange of gas inside the chamber can be obtained in a manner having no, or at least a low, impact on the operational efficiency of the turbine unit of the turbine arrangement.

Optionally, the first opening is provided in a wall of the turbine outlet duct at a position adjacent to an interface between the turbine shroud and the turbine outlet duct. Thereby, even further improved conditions are provided for injecting an exhaust additive to the exhaust gas at a position close to the turbine unit of the turbine arrangement without disturbing the measurements obtained by the sensor. Moreover, since the first opening is provided in a wall of the turbine outlet duct, the exchange of gas inside the chamber can be obtained in a manner having no, or at least a low, impact on the operational efficiency of the turbine unit of the turbine arrangement.

Optionally, the second opening is provided at a different circumferential position of the exhaust conducting section than the first opening. Thereby, a space efficient solution is provided for obtaining a continuous exchange of the gas inside the chamber. Moreover, since the second opening is provided at a different circumferential position of the exhaust conducting section than the first opening, the first and second openings can be arranged at substantially the same distance from a turbine outlet of the turbine unit measured in a direction coinciding with a centre axis of the turbine outlet duct. In this manner, each of the first and second openings can be arranged close to the turbine outlet of the turbine unit while obtaining a continuous exchange of the gas inside the chamber. As a further result, further improved conditions are provided for injecting an exhaust additive to the exhaust gas at a position close to the turbine unit of the turbine arrangement without disturbing the measurements obtained by the sensor.

Optionally, the second opening is provided in a wall of the turbine outlet duct at a position adjacent to an interface between the turbine shroud and the turbine outlet duct. Thereby, each of the first and second openings can be arranged close to the turbine outlet of the turbine unit while obtaining a continuous exchange of the gas inside the chamber. As a further result, conditions are provided for injecting an exhaust additive to the exhaust gas at a position close to the turbine unit of the turbine arrangement without impairing the reliability of the measurements obtained by the sensor.

Optionally, the first opening has a geometrical centre line being angled relative to a geometrical centre line of the second opening. Thereby, a continuous exchange of the gas inside the chamber can be further ensured. Moreover, a continuous flow of gas through the chamber can be provided wherein one of the first and second openings functions as an inlet for gas flowing into the chamber whereas the other of the first and second openings functions as an outlet for gas flowing out from the chamber.

Optionally, one of the first and second openings has a geometrical centre line being substantially perpendicular to a centre axis of the turbine outlet duct. Thereby, conditions are obtained for providing the opening in a simple and cost-efficient manner. Moreover, it can be ensured that a continuous flow of gas is obtained through the chamber in an efficient manner.

Optionally, the second opening has a geometrical centre line being substantially perpendicular to a centre axis of the turbine outlet duct. Thereby, conditions are obtained for providing the second opening in a simple and cost-efficient manner. Moreover, it can be ensured that a continuous flow of gas is obtained through the chamber in an efficient manner.

Optionally, the turbine arrangement comprises an exhaust additive dosing unit arranged to supply an exhaust additive inside the turbine outlet duct. Since the turbine arrangement comprises the sensor arranged to sense a property of gas inside the chamber and since the chamber is fluidly connected to the exhaust conducting section via the first opening provided in the wall of the exhaust conducting section, conditions are provided for arranging the exhaust additive dosing unit to supply the exhaust additive at a position close to the turbine unit of the turbine arrangement without disturbing the measurements obtained by the sensor. In this manner, a high degree of mixing between the exhaust additive and the exhaust gas can be ensured upstream of an SCR catalyst without disturbing the measurements obtained by the sensor.

Optionally, the exhaust additive dosing unit is arranged to supply the exhaust additive at a position closer to the first end portion than to the second end portion. Thereby, conditions are provided for a high degree of mixing between the exhaust additive and the exhaust gas upstream of an SCR catalyst while having conditions for obtaining reliable data from the sensor.

Optionally, the turbine arrangement comprises a distribution device arranged on the turbine unit, and wherein the exhaust additive dosing unit is arranged to supply an exhaust additive onto the distribution device. Thereby, further improved conditions are provided for a high degree of mixing between the exhaust additive and the exhaust gas upstream of an SCR catalyst while having conditions for obtaining reliable data from the sensor.

Optionally, the sensor is a NOx sensor configured to sense a NOx content of the gas inside the chamber. Thereby, conditions are provided for obtaining reliable data from the NOx sensor while avoiding damages to the NOx sensor caused by excessive temperatures and/or pressures.

According to a second aspect of the invention, the object is achieved by a turbo device for an internal combustion engine, wherein the turbo device comprises a turbine arrangement according to some embodiments of the present disclosure, and wherein the turbine unit of the turbine arrangement is configured to be driven by exhaust gas of the internal combustion engine.

Thereby, a turbo device is provided having conditions for obtaining reliable data of the property of exhaust gas flowing through the turbine unit while avoiding damages to the sensor caused by excessive temperatures and/or pressures.

Moreover, the turbo device provides conditions for injecting an exhaust additive to the exhaust gas at a position close to the turbine unit of the turbo device without disturbing the measurements obtained by the sensor.

Accordingly, due to these features, a turbine arrangement is provided having conditions for providing reliable data of the property of exhaust gas flowing through the turbine unit, while being robust and having conditions for adding exhaust additive to the exhaust gas at a position close to the turbine unit of the turbo device without disturbing the measurements obtained by the sensor.

Accordingly, a turbo device is provided overcoming, or at least alleviating, at least some of the above-mentioned problems and drawbacks. As a result, the above-mentioned object is achieved.

According to a third aspect of the invention, the object is achieved by an internal combustion engine comprising a turbo device according to some embodiments of the present disclosure. Since the internal combustion engine comprises a turbo device according to some embodiments, an internal combustion engine is provided overcoming, or at least alleviating, at least some of the above-mentioned problems and drawbacks. As a result, the above-mentioned object is achieved.

According to a fourth aspect of the invention, the object is achieved by a vehicle comprising an internal combustion engine according to some embodiments of the present disclosure. Since the vehicle comprises an internal combustion engine according to some embodiments, a vehicle is provided overcoming, or at least alleviating, at least some of the above-mentioned problems and drawbacks. As a result, the above-mentioned object is achieved.

Further features of, and advantages with, the present invention will become apparent when studying the appended claims and the following detailed description.

### BRIEF DESCRIPTION OF THE DRAWINGS

Various aspects of the invention, including its particular features and advantages, will be readily understood from the example embodiments discussed in the following detailed description and the accompanying drawings, in which:

FIG. 1 schematically illustrates a vehicle according to some embodiments of the present disclosure,

FIG. 2 schematically illustrates an internal combustion engine of the vehicle illustrated in FIG. 1.

FIG. 3 illustrates a cross section of a turbine arrangement of the internal combustion engine illustrated in FIG. 2, and

FIG. 4 illustrates a cross section of a turbine arrangement according to some further embodiments.

### DETAILED DESCRIPTION

Aspects of the present invention will now be described more fully. Like numbers refer to like elements throughout. Well-known functions or constructions will not necessarily be described in detail for brevity and/or clarity.

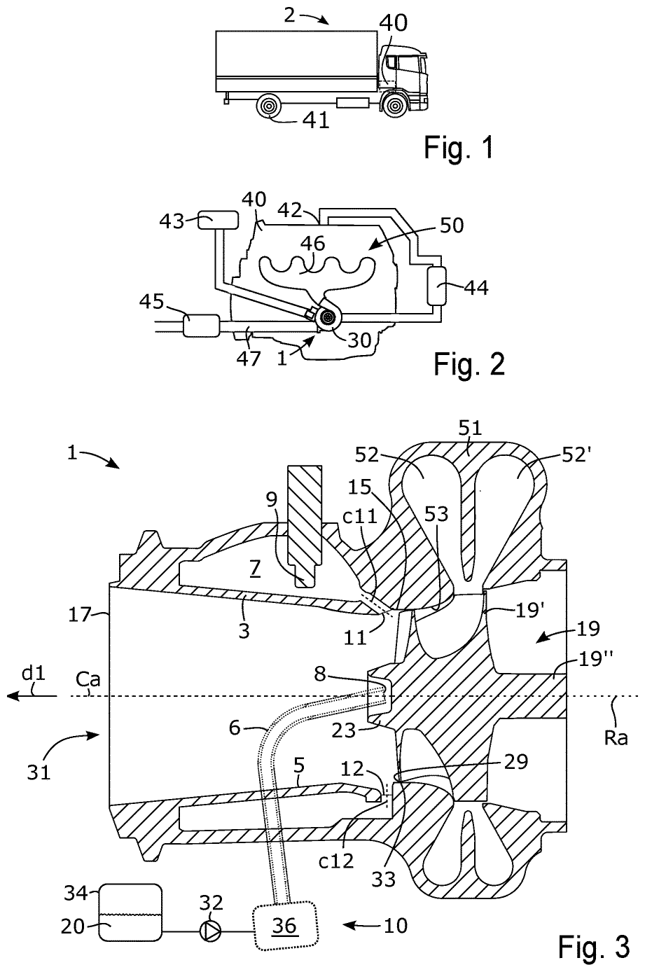

FIG. 1 schematically illustrates a vehicle 2 according to some embodiments of the present disclosure. According to the illustrated embodiments, the vehicle 2 is a truck, i.e., a heavy vehicle. However, according to further embodiments, the vehicle 2, as referred to herein, may be another type of manned or unmanned vehicle for land or water-based propulsion such as a lorry, a bus, a construction vehicle, a tractor, a car, a ship, a boat, or the like.

The vehicle 2 comprises an internal combustion engine 40. According to the illustrated embodiments, the internal combustion engine 40 is configured to provide motive power to the vehicle 2 via wheels 41 of the vehicle 2.

FIG. 2 schematically illustrates the internal combustion engine 40 of the vehicle 2 illustrated in FIG. 1. The internal combustion engine 40 is in some places herein referred to as the “combustion engine 40”, or simply “the engine 40”, for reasons of brevity and clarity. Below, simultaneous reference is made to FIG. 1 and FIG. 2, if not indicated otherwise.

The vehicle 2 may comprise one or more electric propulsion motors in addition to the internal combustion engine 40 for providing motive power to the vehicle 2. Thus, the vehicle 2, as referred to herein, may comprise a so-called hybrid electric powertrain comprising one or more electric propulsion motors in addition to the combustion engine 40 for providing motive power to the vehicle 2.

According to embodiments herein, the internal combustion engine 40 is a four-stroke internal combustion engine. Moreover, according to the illustrated embodiments, the internal combustion engine 40 is a diesel engine, i.e., a type of compression ignition engine. The internal combustion engine 40 may thus be a compression ignition engine configured to operate on diesel or a diesel-like fuel, such as biodiesel, biomass to liquid (BTL), or gas to liquid (GTL) diesel. Diesel-like fuels, such as biodiesel, can be obtained from renewable sources such as vegetable oil which mainly comprises fatty acid methyl esters (FAME). Diesel-like fuels can be produced from many types of oils, such as rapeseed oil (rapeseed methyl ester, RME) and soybean oil (soy methyl ester, SME).

According to further embodiments, the internal combustion engine 40, as referred to herein, may be an Otto engine with a spark-ignition device, wherein the Otto engine may be configured to run on petrol, alcohol, similar volatile fuels, or combinations thereof. Alcohol, such as ethanol, can be derived from renewable biomass. According to some embodiments, the internal combustion engine 40, as referred to herein, may be arranged to power another type of device, system, or unit than a vehicle, such as for example an electric generator, a ship, a boat, or the like.

The combustion engine 40 comprises a turbo device 30. As is further explained herein, the turbo device 30 comprises a turbine arrangement 1 comprising a turbine unit configured to be driven by exhaust gas of the internal combustion engine 40. According to the illustrated embodiments, the turbo device 30 is a turbocharger, i.e., a charging device configured to compress air to an air inlet 42 of the combustion engine 40. Thus, according to these embodiments, the turbine unit of the turbo device 30 is connected to the compressor. According to further embodiments, the turbo device 30, as referred to herein, may be a turbo compound device wherein the turbine unit is connected to an output shaft of the combustion engine 40 or to another shaft or type of device configured to produce useful energy by the rotation of the turbine unit.

According to the illustrated embodiments, the combustion engine 40 comprises an air filter unit 43 and a charge air cooler 44. The compressor of the turbo device 30 is configured to force air from the air filter unit 43 to the air inlet 42 of the combustion engine 40. The charge air cooler 44 is arranged between the compressor of the turbo device 30 and the air inlet 42 of the combustion engine 40. The charge air cooler 44 is configured to cool the compressed air before the air is conducted to the air inlet 42. In this manner, the power output and fuel efficiency of the combustion engine 40 can be improved.

Moreover, according to the illustrated embodiments, the combustion engine 40 comprises a Selective Catalytic Reduction SCR catalyst 45 arranged downstream of the turbine unit of the turbo device 30. Furthermore, the exhaust system 50 comprises an exhaust conduit 47 fluidly connecting the Selective Catalytic Reduction SCR catalyst 45 to the turbine arrangement 1 of the turbo device 30. According to further embodiments, the exhaust system 50 may comprise another type of catalytic converter than a Selective Catalytic Reduction SCR catalyst 45.

FIG. 3 illustrates a cross section of a turbine arrangement 1 according to some embodiments of the internal combustion engine 40 illustrated in FIG. 2. The turbine arrangement 1 comprises a turbine housing 51 and a turbine unit 19 arranged to rotate in the turbine housing 51. The turbine arrangement 1 may also be referred to as a turbine assembly for a turbo device.

The turbine unit 19 is configured to be driven by exhaust gas of an internal combustion engine, such as the combustion engine 40 illustrated in FIG. 2. The turbine arrangement 1 may form part of turbo device in the form of a turbocharger or a turbo device in the form of a turbo compound device. In other words, the turbo device 30 illustrated in FIG. 2 may comprise a turbine arrangement 1 according to the embodiments illustrated in FIG. 3. Therefore, below, simultaneous reference is made to FIG. 2 and FIG. 3 if not indicated otherwise.

The turbine unit 19 is configured to rotate around a rotation axis Ra during operation of a turbo device 30 comprising the turbine arrangement 1. In FIG. 3, the cross section is made in a plane comprising the rotation axis Ra of the turbine unit 19. The turbine unit 19 comprises a turbine 19′ and a shaft 19″ connected to the turbine 19′. The turbine 19′, as referred to herein, may also be referred to as a turbine wheel. According to the illustrated embodiments, the turbine 19′ and the shaft 19″ are formed by one piece of coherent material. According to further embodiments, the turbine 19′ and the shaft 19″ may be separate parts wherein the turbine 19′ is connected to the shaft 19′.

In embodiments in which the turbine arrangement 1 forms part of a turbo device 30 in the form of a turbocharger, the shaft 19″ of the turbine unit 19 is connected to a compressor, such as a compressor explained with reference to FIG. 2. In embodiments in which the turbine arrangement 1 forms part of a turbo device 30 in the form of a turbo compound device, the shaft 19″ of the turbine unit 19 may be connected to an output shaft of a combustion engine 40 or to another shaft or type of device configured to produce useful energy by the rotation of the turbine unit 19.

The turbine housing 51 comprises a turbine inlet scroll 52, 52′. The turbine inlet scroll 52, 52′ may also be referred to as a turbine volute. The turbine inlet scroll 52, 52′ may be fluidly connected to a number of exhaust valves of a combustion engine via an exhaust manifold, such as the exhaust manifold 46 of the combustion engine 40 illustrated in FIG. 2. In more detail, according to the illustrated embodiments, the turbine housing 51 comprises two turbine inlet scrolls 52, 52′. The turbine arrangement 1 may therefore also be referred to as a twin scroll turbine arrangement.

Each of the two turbine inlet scrolls 52, 52′ may be fluidly connected to exhaust valves of a number of cylinders of the combustion engine 40 via a separate exhaust manifold. In other words, a first inlet scroll 52 of the two turbine inlet scrolls 52, 52′ may be fluidly connected to exhaust valves of a first set of cylinders of the combustion engine 40 via a first exhaust manifold, wherein a second inlet scroll 52′ of the two turbine inlet scrolls 52, 52′ is fluidly connected to exhaust valves of a second set of cylinders of the combustion engine 40 via a second exhaust manifold, and wherein the second set of cylinders is different from the first set of cylinders. In this manner, the pulsating flow of exhaust gas obtained from the total number of cylinders of the combustion engine 40 can be utilized in a more efficient manner to increase the efficiency of the turbine arrangement 1.

The turbine housing 51 further comprises an exhaust conducting section 31 comprising a turbine shroud 53 and a turbine outlet duct 3. The turbine shroud 53 encloses at least a portion of the turbine 19′ of the turbine unit 19. The turbine outlet duct 3 is arranged downstream of the turbine 19′ of the turbine unit 19 and is configured to receive exhaust gas from the turbine 19′ of the turbine unit 19. In more detail, the turbine unit 19 comprises a turbine outlet 29 facing the turbine outlet duct 3, wherein the turbine outlet duct 3 is configured to receive exhaust gas from the turbine outlet 29. As defined herein, the turbine outlet 29 is positioned at an interface 33 between the turbine shroud 53 and the turbine outlet duct 3.

Moreover, the turbine outlet duct 3 comprises a first and a second end portion 15, 17, wherein the first end portion 15 is arranged at the interface 33 between the turbine shroud 53 and the turbine outlet duct 3. According to the illustrated embodiments, the turbine outlet duct 3 has a frustoconical inner surface formed by a wall 5 thereof. According to further embodiments, the inner surface of the turbine outlet duct 3 may have another shape than frustoconical. The effective cross-sectional area of the turbine outlet duct 3, measured in a plane perpendicular to a centre axis Ca of the turbine outlet duct 3, increases along an intended flow direction d1 through the turbine outlet duct 3. The intended flow direction d1 through the turbine outlet duct 3 coincides with a direction pointing from the first end portion 15 of the turbine outlet duct 3 towards the second end portion 17 of the turbine outlet duct 3.

Thus, according to the illustrated embodiments, the turbine outlet duct 3 functions as a diffuser which reduces the flow velocity and increases the static pressure along the intended flow direction d1 inside the turbine outlet duct 3. Therefore, the turbine outlet duct 3, as referred to herein, may also be referred to as a diffuser pipe, a diffuser, or the like.

During operation of the turbine arrangement 1, the exhaust gas is flowing from the two turbine inlet scrolls 52, 52′ into the turbine 19′ of the turbine unit 19, through the turbine shroud 53, and into the turbine outlet duct 3 via the turbine outlet 29. As understood from the above, the flow of exhaust gas through the turbine 19′ causes rotation of the turbine unit 19 around the rotation axis Ra.

According to the illustrated embodiments, the turbine outlet duct 3 forms part of the turbine housing 51 but may also be a separate part attached to the turbine housing 51. However, since the turbine outlet duct 3 forms part of the turbine housing 51 according to the illustrated embodiments, the turbine outlet duct 3, as referred to herein, may also be referred to as a turbine housing or a portion of a turbine housing downstream of a turbine outlet 29 of a turbine unit 19 of the turbine arrangement 1.

Moreover, as understood from the above, the turbine shroud 53 and the turbine outlet duct 3 are collectively referred to as an exhaust conducting section 31 of the turbine arrangement 1. According to the illustrated embodiments, the turbine shroud 53 and the turbine outlet duct 3 are formed by one piece of coherent material. According to further embodiments, the turbine shroud 53 and the turbine outlet duct 3 may each be formed by separate piece of material and may be assembled to each other to form the exhaust conducting section 31.

According to embodiments herein, the turbine housing 51 comprises a first opening 11 provided in a wall 5 of the exhaust conducting section 31 and a chamber 7 fluidly connected to the exhaust conducting section 31 via the first opening 11. According to the embodiments illustrated in FIG. 3, the first opening 11 is provided in a wall 5 of the turbine outlet duct 3. In other words, according to the embodiments illustrated in FIG. 3, the chamber 7 is fluidly connected to the turbine outlet duct 3 via the first opening 11.

The turbine arrangement 1 further comprises a sensor 9 arranged to sense a property of gas inside the chamber 7. According to the illustrated embodiments, the sensor 9 is a NOx sensor configured to sense a NOx content of the gas inside the chamber 7. According to further embodiments, the sensor 9 may be another type of sensor configured to sense another type of property of the gas inside the chamber 7, such as a temperature sensor configured to sense the temperature of the gas inside the chamber 7 or an oxygen sensor configured to sense an oxygen content of the gas inside the chamber 7.

Since the sensor 9 is arranged to sense a property of the gas inside the chamber 7, which is fluidly connected to the turbine outlet duct 3 via the first opening 11 provided in the wall 5 of the turbine outlet duct 3, conditions are provided for obtaining reliable data of the property of the gas inside the chamber 7, while avoiding damages to the sensor 9 caused by excessive temperatures and/or pressures. The property of the gas inside the chamber 7 is representative of the property of the exhaust gas flowing through the exhaust conducting section 31 because the chamber 7 is fluidly connected to the turbine outlet duct 3 via the first opening 11.

Moreover, due to these features, conditions are provided for injecting an exhaust additive 20 to the exhaust gas at a position close to the turbine unit 19′ of the turbine arrangement 1 without disturbing the measurements obtained by the sensor 9, as is further explained herein. As seen in FIG. 3, the turbine arrangement 1 according to the illustrated embodiments comprises an exhaust additive dosing unit 6 arranged to supply an exhaust additive 20 inside the turbine outlet duct 3. According to the illustrated embodiments, the exhaust additive dosing unit 6 is arranged to supply the exhaust additive 20 at a position closer to the first end portion 15 than to the second end portion 17.

In more detail, according to the illustrated embodiments, the turbine arrangement 1 comprises an exhaust additive dosing arrangement 10 comprising the exhaust additive dosing unit 6. The exhaust additive dosing arrangement 10 comprises an exhaust additive storage unit 34 configured to accommodate exhaust additive 20, such as an aqueous urea solution, and a pump 32 configured to pump exhaust additive 20 from the exhaust additive storage unit 34 to the exhaust additive dosing unit 6.

The exhaust additive dosing unit 6 is formed as a supply tube which protrudes into the turbine outlet duct 3. The exhaust additive dosing unit 6 comprises an opening 8 for the supply of the exhaust additive 20 to the stream of exhaust gas inside the turbine outlet duct 3. According to the illustrated embodiments, the exhaust additive dosing unit 6 is arranged such that a centre axis Ca of the turbine outlet duct 3 extends through the opening 8 of the exhaust additive dosing unit 6.

Moreover, the exhaust additive dosing arrangement 10 may comprise some further components 36 between the pump 32 and the exhaust additive dosing unit 6. In FIG. 3, such further components 36 are indicated with the reference sign 36 and may comprise further tubing, a dosing valve, and the like.

The exhaust additive dosing arrangement 10 according to the illustrated embodiments is an airless exhaust additive dosing arrangement 10 meaning that the exhaust additive 20 is supplied to exhaust gas without the use of pressurized air as is the case in some other types of exhaust additive dosing arrangements. However, according to further embodiments, the exhaust additive dosing arrangement 10 of the turbine arrangement 1 may utilize pressurized air for supplying exhaust additive to the stream of exhaust gas inside the turbine outlet duct 3.

According to the illustrated embodiments, the turbine arrangement 1 comprises a distribution device 23 arranged on the turbine unit 19, and wherein the exhaust additive dosing unit 6 is arranged to supply an exhaust additive 20 onto the distribution device 23. The distribution device 23 is arranged at a centre of the turbine unit 19 meaning that the rotational axis Ra of the turbine unit 19 extends through the distribution device 23.

As is apparent from FIG. 3, according to the illustrated embodiments, the rotational axis Ra of the turbine unit 19 coincides with the centre axis Ca of the turbine outlet duct 3. According to the illustrated embodiments, the distribution device 23 form part of the turbine 19′ of the turbine unit 19, i.e., the distribution device 23 and the turbine 19′ are formed by one piece of coherent material. According to further embodiments, the distribution device 23 may be a separate part attached to the turbine unit 19 for example by welding and/or by one or more fastening elements.

According to the illustrated embodiments, the distribution device 23 is cup-shaped and the exhaust additive dosing unit 6 protrudes into an open face of the cup-shaped distribution device 23 such that the opening 8 of the exhaust additive dosing unit 6 is positioned inside the cup-shaped distribution device 23. Since the distribution device 23 corotates with the turbine unit 19 at high rotational speeds, an efficient distribution and atomisation of exhaust additive 20 is provided. In addition, the cup-shape of the distribution device 23 prevents back-flow from a rim of the cup-shaped distribution device 23 and reduces the risk of exhaust additive 20 being unintentionally deposited on surfaces of the turbine 19′.

According to further embodiments, the distribution device 23 may have another shape. As an example, according to some embodiments, the distribution device 23 may comprise a receiving surface forming a patterned facial surface. This patterned surface may be used to control and optimise the distribution of exhaust additive in the exhaust stream. As an alternative, or in addition, the exhaust additive distribution device 23 may comprise a radial wall, wherein the receiving surface exhaust additive distribution device 23 is an inner face of the radial wall, wherein the exhaust additive distribution device 23 comprises a distribution surface of an orifice formed in the radial wall, and wherein the orifice extends between an inner face of the radial wall and an outer surface of the radial wall.

Moreover, according to further embodiments, the exhaust additive dosing unit 6 may be configured to supply exhaust additive to the stream of exhaust gas inside the turbine outlet duct 3 in another manner than onto a distribution device 23. According to the embodiments illustrated in FIG. 3, the exhaust additive dosing unit 6 is arranged to supply the exhaust additive 20 to the stream of exhaust gas inside the turbine outlet duct 3 at a position located adjacent to the first end portion 15 of the turbine outlet duct 3. In this manner, it can be ensured that the exhaust additive 20 and the exhaust gas are mixed to a great extent before the mixture is reaching a Selective Catalytic Reduction SCR catalyst 45 of the combustion engine 40.

Furthermore, as seen in FIG. 3, according to the illustrated embodiments, the first opening 11 is provided in the wall 5 of the turbine outlet duct 3 at a position closer to the first end portion 15 than to the second end portion 17. In more detail, according to the illustrated embodiments, the first opening 11 is provided in the wall 5 of the turbine outlet duct 3 at a position adjacent to the interface 33 between the turbine shroud 53 and the turbine outlet duct 3.

Due to these features, the sensor 9 can be used to obtain reliable data of the property of exhaust gas in the chamber 7 while avoiding damages to the sensor 9 caused by excessive temperatures and/or pressures. Furthermore, due to these features the adding of the exhaust additive 20 to the stream of exhaust gas inside the turbine outlet duct 3 does not disturb the measurements obtained by the sensor 9.

According to the illustrated embodiments, the chamber 7 is arranged radially outside of the turbine outlet duct 3 and encloses substantially the entire circumference of the turbine outlet duct 3. According to further embodiments, the chamber 7 is arranged radially outside of the turbine outlet duct 3 and encloses more than 25%, or more than 50%, of the circumference of the turbine outlet duct 3.

According to the embodiments illustrated in FIG. 3, the first opening 11 faces the turbine 19′ of the turbine unit 19. Thereby, it can be ensured that the exhaust gas inside the chamber 7 is exchanged continuously by pressure fluctuations at the first opening 11 and/or by obtaining a continuous flow of exhaust gas into the first opening 11, as is further explained in the following.

The turbine outlet duct 3 comprises a second opening 12 provided in the wall 5 turbine outlet duct 3 of the exhaust conducting section 31. The chamber 7 is fluidly connected to turbine outlet duct 3 via the second opening 12.

The second opening 12 is arranged closer to the first end portion 15 than to the second end portion 17 of the turbine outlet duct 3. In more detail, the second opening 12 is provided in a wall 5 of the turbine outlet duct 3 at a position adjacent to the interface 33 between the turbine shroud 53 and the turbine outlet duct 3.

As seen in FIG. 3, the first opening 11 has a geometrical centre line c11 being angled relative to a geometrical centre line c12 of the second opening 12. In this manner, a continuous flow of exhaust gas can be obtained into the first opening 11, through the chamber 7, and out of the chamber 7 via the second opening 12.

In more detail, according to the illustrated embodiments, the geometrical centre line c11 of the first opening 11 is transversal to a plane perpendicular to the centre axis Ca of the turbine outlet duct 3 whereas the geometrical centre line c12 of the second opening 12 is substantially perpendicular to the centre axis Ca of the turbine outlet duct 3, i.e., is substantially parallel to a plane perpendicular to the centre axis Ca. In this manner, a continuous flow of exhaust gas through the chamber 7 can be further ensured.

According to further embodiments, the first opening 11 may have geometrical centre line being substantially perpendicular to a centre axis Ca of the turbine outlet duct 3, wherein the geometrical centre line of the second opening 12 is transversal to a plane perpendicular to the centre axis Ca, and wherein the second opening 12 faces in a direction away from the turbine 19′ of the turbine unit 19. Also in this manner, a continuous flow of exhaust gas can be ensured through the chamber 7.

The term geometrical centre line c11, c12 as used herein means a line extending through a geometrical centre of the respective first and second openings 11, 12. A geometrical centre is a centre at which the distances to delimiting surfaces of the respective first and second openings 11, 12, are maximized in all radial directions.

As can be seen in FIG. 3, the second opening 12 is provided at a different circumferential position of the exhaust conducting section 31 than the first opening 11. This allows the first and second openings to be arranged at substantially the same distance from the turbine outlet 29 of the turbine unit 19 measured in a direction d1 coinciding with the centre axis Ca of the turbine outlet duct 3 while ensuring a continuous flow of exhaust gas through the chamber 7.

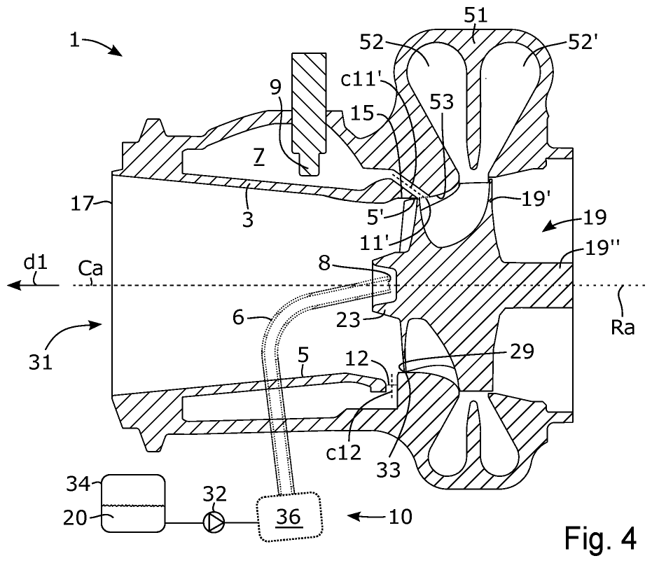

FIG. 4 illustrates a cross section of a turbine arrangement 1 according to some further embodiments. The internal combustion engine 40 illustrated in FIG. 2 may comprise a turbine arrangement 1 according to the embodiments illustrated in FIG. 4. Therefore, below, simultaneous reference is made to FIG. 2 and FIG. 4, if not indicated otherwise. The turbine arrangement 1 illustrated in FIG. 4 comprises the same features, functions, and advantages as the turbine arrangement 1 illustrated in FIG. 3, with some exceptions explained below.

According to the embodiments illustrated in FIG. 4, the turbine housing 51 of the turbine arrangement 1 comprises a first opening 11′ provided in a wall 5′ of the turbine shroud 53 of the exhaust conducting section 31. Also in these embodiments, the first opening 11′ faces the turbine 19′ of the turbine unit 19. Thereby, it can be ensured that the exhaust gas inside the chamber 7 is exchanged continuously by pressure fluctuations at the first opening 11′ and/or by obtaining a continuous flow of exhaust gas into the first opening 11′, as is further explained in the following.

That is, also in these embodiments, the turbine outlet duct 3 comprises a second opening 12 provided in the wall 5 turbine outlet duct 3 of the exhaust conducting section 31. The chamber 7 is fluidly connected to turbine outlet duct 3 also via the second opening 12.

Also in the embodiments illustrated in FIG. 4, the second opening 12 is arranged closer to the first end portion 15 than to the second end portion 17 of the turbine outlet duct 3. In more detail, the second opening 12 is provided in a wall 5 of the turbine outlet duct 3 at a position adjacent to the interface 33 between the turbine shroud 53 and the turbine outlet duct 3.

As seen in FIG. 4, the first opening 11′ has a geometrical centre line c11′ being angled relative to a geometrical centre line c12 of the second opening 12. In this manner, a continuous flow of exhaust gas can be obtained in an efficient manner into the first opening 11′, through the chamber 7, and out of the chamber 7 via the second opening 12.

Moreover, also in these embodiments, the geometrical centre line c11′ of the first opening 11′ is transversal to a plane perpendicular to the centre axis Ca of the turbine outlet duct 3 whereas the geometrical centre line c12 of the second opening 12 is substantially perpendicular to the centre axis Ca of the turbine outlet duct 3, i.e., is substantially parallel to a plane perpendicular to the centre axis Ca. In this manner, a continuous flow of exhaust gas through the chamber 7 can be further ensured.

According to the embodiments illustrated in FIG. 4, the first opening 11′ is provided in a wall 5′ of the turbine shroud 53 at a position close to the interface 33 between the turbine outlet duct 3 and the turbine shroud 53, i.e., at a position close to the turbine outlet 29 of the turbine 19′. According to further embodiments, the first opening 11′ may be provided further upstream in the wall 5′ of the turbine shroud 53 than depicted in FIG. 4.

Moreover, according to further embodiments, the turbine housing 51 of the turbine arrangement 1 may comprise a first opening having a first delimiting wall at the wall 5 of the turbine outlet duct 3 and a second delimiting wall at the wall 5′ of the turbine shroud 53. In other words, according to such embodiments, the first opening may extend from the wall 5 of the turbine outlet duct 3, past the interface 33 between the turbine outlet duct 3 and the turbine shroud 53, into the turbine shroud 53.

The wording “substantially perpendicular to”, as used herein, may encompass that the angle between the objects referred to is within the range of 80-100 degrees or is within the range of 83-97 degrees.

The wording “substantially parallel to”, as used herein, may encompass that the angle between the objects referred to is less than 10 degrees, or is less than 7 degrees.

The wording “substantially the same distance”, as used herein, may encompass that the distances, or measurements, referred to deviates less than 15% from each other.

The wording “adjacent to”, as used herein, may encompass that the objects referred to is within 1-2 centimetres from each other.

The wording “close to”, as used herein, may encompass that the objects referred to is within 1-2 centimetres from each other.

The turbine arrangement 1 for a turbo device 30 of an internal combustion engine 40, as referred to herein, may also be referred to as “a turbine arrangement 1 for a turbo device 30 configured to extract energy from exhaust gasses flowing through an exhaust system 50 of an internal combustion engine 40”.

The wording upstream and downstream, as used herein, relates to the relative positions of objects in relation to an intended flow direction of fluid in the system referred to. As an example, the feature that a first object is arranged upstream of a second object in a system means that the first object is arranged before the second object seen relative to the intended flow direction of fluid through the system. As another example, the feature that a first object is arranged downstream of a second object in a system means that the first object is arranged after the second object seen relative to the intended flow direction of fluid through the system.

It is to be understood that the foregoing is illustrative of various example embodiments and that the invention is defined only by the appended independent claims. A person skilled in the art will realize that the example embodiments may be modified, and that different features of the example embodiments may be combined to create embodiments other than those described herein, without departing from the scope of the present invention, as defined by the appended independent claims.

As used herein, the term “comprising” or “comprises” is open-ended, and includes one or more stated features, elements, steps, components, or functions but does not preclude the presence or addition of one or more other features, elements, steps, components, functions, or groups thereof.

1. A turbine arrangement for a turbo device of an internal combustion engine,
wherein the turbine arrangement comprises a turbine housing and a turbine unit arranged to rotate in the turbine housing,
wherein the turbine housing comprises:
an exhaust conducting section comprising a turbine shroud and a turbine outlet duct,
a first opening provided in a wall of the exhaust conducting section, and
a chamber fluidly connected to the exhaust conducting section via the first opening,
and wherein the turbine arrangement comprises a sensor arranged to sense a property of gas inside the chamber,
wherein the turbine outlet duct comprises a second opening provided in the wall of the exhaust conducting section, and wherein the chamber is fluidly connected to the exhaust conducting section via the second opening,
and wherein the turbine outlet duct comprises a first and a second end portion, wherein the first end portion is arranged at an interface between the turbine shroud and the turbine outlet duct,
characterized in that the second opening is arranged closer to the first end portion than to the second end portion.

2. The turbine arrangement according to claim 1, wherein the first opening faces the turbine unit.

3. The turbine arrangement according to claim 1, wherein the chamber is arranged radially outside of the turbine outlet duct and encloses more than 25%, or more than 50%, of the circumference of the turbine outlet duct.

4. The turbine arrangement according to claim 1, wherein the first opening is provided in a wall of the turbine outlet duct at a position closer to the first end portion than to the second end portion.

5. The turbine arrangement according to claim 1, wherein the first opening is provided in a wall of the turbine outlet duct at a position adjacent to an interface between the turbine shroud and the turbine outlet duct.

6. The turbine arrangement according to claim 1, wherein the second opening is provided at a different circumferential position of the exhaust conducting section than the first opening.

7. The turbine arrangement according to claim 1, wherein the second opening is provided in a wall of the turbine outlet duct at a position adjacent to an interface between the turbine shroud and the turbine outlet duct.

8. The turbine arrangement according to claim 1, wherein the first opening has a geometrical centre line being angled relative to a geometrical centre line of the second opening.

9. The turbine arrangement according to claim 1, wherein the turbine arrangement comprises an exhaust additive dosing unit arranged to supply an exhaust additive inside the turbine outlet duct.

10. The turbine arrangement according to claim 9, wherein the exhaust additive dosing unit is arranged to supply the exhaust additive at a position closer to the first end portion than to the second end portion.

11. The turbine arrangement according to claim 9, wherein the turbine arrangement comprises a distribution device arranged on the turbine unit, and wherein the exhaust additive dosing unit is arranged to supply an exhaust additive onto the distribution device.

12. The turbine arrangement according to claim 1, wherein the sensor is a NOx sensor configured to sense a NOx content of the gas inside the chamber.

13. A turbo device for an internal combustion engine, wherein the turbo device comprises a turbine arrangement according to claim 1, and wherein the turbine unit of the turbine arrangement is configured to be driven by exhaust gas of the internal combustion engine.

14. An internal combustion engine comprising a turbo device according to claim 13.

15. A vehicle comprising an internal combustion engine according to claim 14.
